(19) United States
(12) Patent Application Publication
(10) Pub. No.: US 2019/0220882 A1
(43) Pub. Date: Jul. 18, 2019

(54) CROWDFUNDING FOR INCENTIVIZING PROFESSIONAL ATHLETES

(71) Applicant: FanAngel, LLC, Park City, UT (US)

(72) Inventor: Shawn P. Fojtik, Park City, UT (US)

(21) Appl. No.: 16/327,818

(22) PCT Filed: Jul. 13, 2015
(86) PCT No.: PCT/US15/40212

§ 371 Date: Feb. 23, 2019

Related U.S. Application Data
(60) Provisional application No. 62/023,131, filed on Jul. 10, 2014.
(60) Provisional application No. 62/126,419, filed on Feb. 27, 2015.
(60) Provisional application No. 62/054,352, filed on Sep. 23, 2014.

(51) Int. Cl. G06Q 30/02; G06Q 20/10

(52) U.S. Cl. CPC G06Q 30/0215; G06Q 20/10

(57) ABSTRACT

A crowdfunding program for sports based crowdfunding efforts is configured to enable users, or sports fans, to provide selected athletes with incentive to complete various conditional actions. Examples of conditional actions for which incentive may be provided include, but are not limited to, the athlete's association with a particular team, the athlete's performance and the like.

### CROSS-REFERENCE TO RELATED APPLICATIONS

Claims for the benefit of priority are made to the filing dates of U.S. Provisional Patent Application No. 62/023,131, filed on Jul. 10, 2014, and titled FAN-BASED COMPENSATION SYSTEM (“the '131 U.S. Provisional Application”), U.S. Provisional Patent Application No. 62/054,352, filed on Sep. 23, 2014, and titled FAN-BASED COMPENSATION SYSTEM (“the '352 U.S. Provisional Application”), U.S. Provisional Patent Application No. 62/126,419, filed on Feb. 27, 2015, and titled CROWDFUNDING FOR INCENTIVIZING PROFESSIONAL ATHLETES (“the '419 U.S. Provisional Application”) and U.S. Provisional Patent Application No. 62/130,591, filed on Mar. 9, 2015, and titled CROWDFUNDING FOR INCENTIVIZING AMATEUR ATHLETES (“the '591 U.S. Provisional Application”). The entire disclosures of the '131 U.S. Provisional Application, the '352 U.S. Provisional Application, the '419 U.S. Provisional Application and the '591 U.S. Provisional Application are hereby incorporated herein.

### TECHNICAL FIELD

This disclosure relates generally to methods and systems for crowdfunding and, more specifically, to methods and systems for sports-based crowdfunding efforts. Even more specifically, this disclosure relates to crowdfunding methods and systems that enable sports fans to collectively fund various actions by specific athletes.

### RELATED ART

Conventionally, professional athletes have been compensated by their teams or their leagues. In many leagues, certain restraints are placed on the manner in which a professional sports team may compensate its players. For example, maximums are placed on the amount an individual professional athlete may be compensated by his or her team and the length of the professional athlete's contract. Professional players' salaries may also be subjected to league minimums. Some sports leagues subject the teams themselves to collective salary caps and, if those caps are exceeded, to so-called “luxury taxes.”

Even in professional sports leagues where no individual or team caps are imposed, the financial resources of some professional sports teams are limited, which may limit the amount of money that a team may offer to its best players.

Maximum salaries, team salary caps, financial limitations and other factors may adversely affect a professional sports team's ability to pay, and thus, retain, its most valued professional athletes, and to attract so-called “free agent” athletes.

Outside of the constraints, if any, of the professional sports leagues in which they play, professional athletes may receive significant amounts of additional compensation from endorsement contracts. A professional athlete's ability to obtain endorsement deals and the amount of compensation that professional athlete may receive from endorsement deals depend upon a number of factors, including the professional athlete's popularity and, in some cases, upon the media exposure and endorsement opportunities available in the location in which their team is based. Some endorsement deals provide for greater compensation when the professional athlete plays for a team that is based in a larger media market (e.g., New York City, Los Angeles, Chicago, etc.) in which the sponsor's products or services are likely to receive greater exposure from their association with the professional athlete. Compensation from the same endorsement deals may diminish along with the size of the media market in which the professional athlete's team is based.

In some cases, endorsement opportunities may make up for professional sports team's inability to provide a particular professional athlete with the most lucrative contract that athlete can command, and may even persuade the professional athlete to stay with or join a team that cannot provide the professional athlete with the best available contract. Such is often the case when a professional athlete is willing to give a particular team a so-called “hometown discount.” In other cases, a professional athlete may look to a combination of team contracts and endorsements to maximize his or her total compensation.

### SUMMARY

A crowdfunding program according to this disclosure is designed to enable individual sports fans to contribute to a professional athlete's overall compensation. As used herein, the term “program” refers to crowdfunding methods, to crowdfunding systems and/or to computer programs for executing crowdfunding methods and for enabling crowdfunding systems.

A crowdfunding system may include one or more servers, each including one or more processors, for administering a crowdfunding method. Thus, a crowdfunding system may be configured to communicate with (e.g., to be networked with, etc.) a number of other devices, including third party servers and user devices, from which the crowdfunding system may receive data, instructions or other information and/or to which the crowdfunding system may deliver data, instructions or other information. In some embodiments, the other devices that communicate with the server or servers of a crowdfunding system may be considered to be part of the crowdfunding system.

The crowdfunding program may provide a user interface (e.g., a webpage or other interface displayed on a user device that has been networked with the crowdfunding system, etc.) through which an individual fan may select a professional sports athlete, one or more conditional actions for which the professional athlete may be compensated and the amount of compensation that the fan will contribute to the professional athlete if the athlete performs the one or more conditional actions. The user interface may be associated with a clearinghouse through which contributions from any number of sports fans may be gathered, and from which the professional athlete, the sports fans who have contributed and potentially others (e.g., the media, the general public, etc.) may receive information about the cumulative value of the contributions that have been contributed and/or pledged, demographic and/or geographic information about contributions and/or pledges from sports fans, information that relates to the conditional action(s) or the like. Upon meeting a particular condition, the professional athlete may receive the funds that have been contributed and/or pledged by one or more sports fans.

Various embodiments of conditional actions for which a professional athlete may receive fan-based compensation include, but are not limited, to, signing a contract with a particular team, meeting a personal performance goal, meeting a team performance goal and thanking the sports fans who contributed to the professional athlete for achieving that goal for their support. The conditional actions may be set based on the professional athlete's current contract status, the position the professional athlete plays, the professional sports team for which the athlete plays or any of a number of other factors. A predetermined time period may be associated with each conditional action (e.g., the end of a particular athlete's free agency, the end of a game, the end of a regular season, the end of a particular playoff round, the end of the entire season, including playoffs, etc.). An administrator of the crowdfunding program may define the conditional actions required of a particular professional athlete, or the conditional actions may be set individually by one or more sports fans. Alternatively, conditional actions may be defined on the basis of a consensus between a plurality of sports fans, with the consensus being derived from a plurality of common conditional actions that have been submitted by a plurality of individual sports fans.

Once one or more conditional actions for a particular professional athlete have been established, those conditional actions may be made available to sports fans who may have an interest in the particular professional athlete to whom the conditional actions correspond. The availability of information about such conditional actions to sports fans may occur in one or more of a variety of different ways. As an example, a sports fan may see a new conditional action or an unmet, but ongoing conditional action (an “active conditional action”) for a particular athlete as the sports fan, through a user interface of the crowdfunding program, accesses a player profile page for that athlete or accesses the user's own personalized page. As another example, the crowdfunding program may push automated messages (e.g., via e-mail, messaging service, etc.) regarding conditional actions for a particular professional athlete to sports fans who have expressed a particular interest in that professional athlete. In yet another example, new and/or active conditional actions for a professional athlete may be delivered to the media, which can make them available to a wider audience.

When a conditional action has been established for a particular professional athlete, and while the conditional action remains active, fans may contribute and/or pledge contributions to the professional athlete in the event that he or she meets the conditional action. Contributions may be made and/or pledged through a user interface associated with the crowdfunding program. The manner or manners in which contributions may be made and/or pledged may be defined by crowdfunding program, and may comprise any of a number of suitable techniques. As an example, a contribution or pledge may be made when a user provides the crowdfunding system (or a financial transaction system that has partnered with the crowdfunding system) with payment information and authorization to consummate a transaction in the event that conditional action is met. As another example, an actual contribution may be made, and then the funds may be placed in an escrow account until the professional athlete either completes the conditional action or fails to complete the conditional action.

While a conditional action for a particular professional athlete remains active; i.e., until the professional athlete completes the conditional action before the end of a predetermined time period (e.g., the signing of a contract, the end of a game, the end of a regular season, the end of a particular playoff round, etc.), updates that correspond to the conditional action may be provided. These updates may include information on the cumulative amount of funding that has been contributed and/or pledged by sports fans toward the conditional action, demographic and/or geographic information about the contributions and/or pledges that have been made toward the conditional action and news about activities that relate to the conditional action, such as rumors and status updates on the professional athlete's ongoing contract talks and contract negotiations, the professional athlete's progress toward a performance-based conditional action or the like. Information about the contributions and/or pledges that have been made toward a particular conditional action may be provided by the crowdfunding system. Other information may be collected by the crowdfunding system, and then made available by or output by the crowdfunding program in combination with information derived from the crowdfunding program. Alternatively, a third party, such as a media outlet, may obtain information from the crowdfunding program, combine that information with current rumors and/or news about activities that pertain to a certain active conditional action, and then output that information together.

In embodiments where the crowdfunding program provides information that relates to a particular active conditional action by a particular professional athlete, the crowdfunding program may make that information available to users or other individuals who access the crowdfunding system (e.g., as links on the professional athlete's page, on each interested user's personalized user page, etc.). Optionally, the crowdfunding program may send users automated updates of rumors or news relating to a particular active conditional action by a particular professional athlete (e.g., by way of automated messages sent via e-mail, a messaging service, etc.). Without limitation, such information may be sent to users who have contributed and/or pledged to contribute money to the professional athlete if he or she meets the conditional action, to users who have previously made a contribution and/or a pledge to contribute money to the professional athlete if he or she met another conditional action and/or to users who have requested updates on information that may relate to the status of the professional athlete's progress toward reaching the conditional action. The crowdfunding system may also use such information in its marketing efforts or distribute such information to media outlets, which may encourage others to participate in the effort to influence the professional athlete (e.g., his or her decision on which team to sign with, his or her performance as an individual, his or her performance as a teammate, etc.).

In some embodiments, the amount that has been contributed to an escrow account for a particular amateur athlete when the amateur athlete completes a conditional action may be reduced. Reductions may occur for certain types of penalties or fouls, or for other egregious acts. If a reduction occurs, the reduced amount(s) may be refunded to the users from which the funds originated.

In the event that a professional athlete complies with each conditional action tied to a particular group of funds, the crowdfunding program may release those funds to the professional athlete.

Other aspects, as well as features and advantages of various aspects, of the disclosed subject matter will become apparent to those of ordinary skill in the art through consideration of the ensuing description, the accompanying drawings and the appended claims.

### BRIEF DESCRIPTION OF THE DRAWINGS

In the drawings:

FIG. 1 schematically illustrates an embodiment of a crowdfunding system according to this disclosure;

FIG. 2 is a schematic representation of a crowdfunding program in which an individual selects a professional athlete, one or more conditional actions for that professional athlete and contributes or pledges a contribution to the professional athlete if the professional athlete meets the one or more conditional actions;

FIG. 3 is a diagram illustrating the flow of the manner in which an individual sports fan may interact with a crowdfunding system to contribute or to pledge a contribution to a particular professional athlete if the professional athlete completes one or more conditional actions;

FIG. 4 shows an embodiment of a user page generated by the crowdfunding system;

FIG. 5 shows an embodiment of a web page generated by the crowdfunding system that corresponds to a particular professional athlete; and

FIGS. 6 and 7 illustrate embodiments of sporting event pages generated by the crowdfunding system.

### DETAILED DESCRIPTION

Systems, devices, software, methods and computer program products according to this disclosure may be configured to enable sports fans to contribute to the overall compensation of user-selected professional athletes (e.g., their favorite professional athletes, etc.), or of any other athletes to whom the sports fans choose to contribute. Such contributions may be made outside of the context of the team-player relationship and, thus, outside of any constraints that might otherwise by imposed by a sports league on the team-player relationship. In addition to providing a forum and clearinghouse by which sports fans may incentivize professional athletes by selecting a professional athlete and contributing to or pledging contributions to the professional athlete for completing one or more conditional actions, a crowdfunding program according to this disclosure may serve as a source for rumors, news or other information that may relate to various conditional actions a professional athlete may complete.

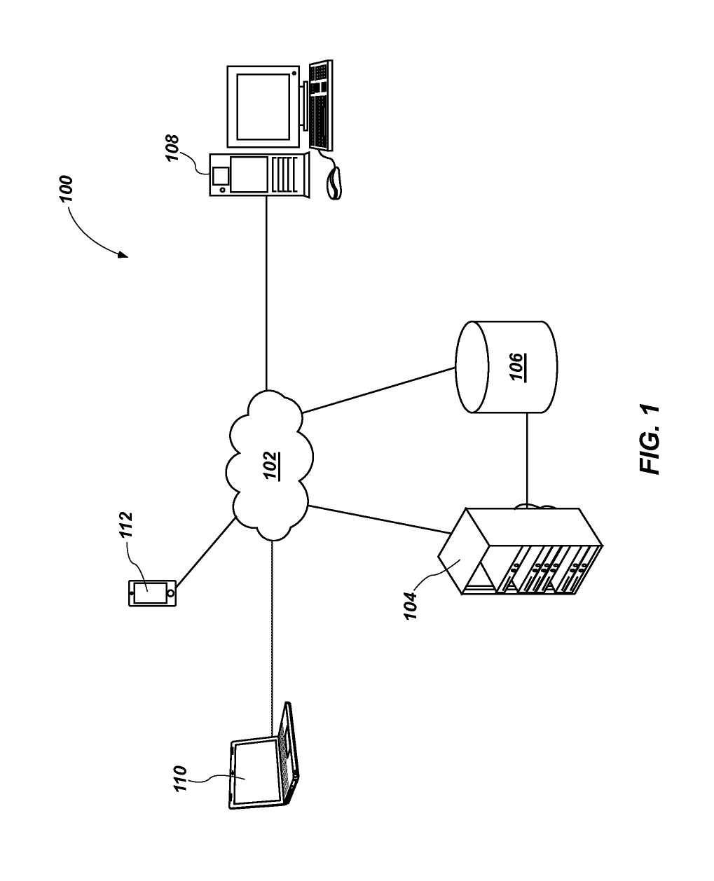

Turning now to FIG. 1, an embodiment of a crowdfunding system 100 is shown that comprises a distributed system usable with a crowdfunding program according to this disclosure. FIG. 1 is intended to illustrate an embodiment of a system; it is not intended to limit the disclosure to any specific structure or arrangement. Rather, any alternative embodiment of system capable of being used in whole or in part with the methods, systems, computer program products or the like disclosed herein—whether such system now exists or is developed in the future—falls within the scope of this disclosure.

In the illustrated crowdfunding system 100, the operation of the crowdfunding system 100 may include a network 102 facilitating communication between a one or more servers 104 and/or data stores 106 and one or more end user devices 108-112. In some embodiments, the servers 104 and, optionally, the data stores 106, or other systems, devices or components may facilitate communication between two or more end user devices 108-112. In some embodiments, authentication systems (e.g., hardware and/or software, etc.) may be provided to require device authentication, message authentication, and the like.

While FIG. 1 illustrates a single network 102 with a single server 104 and a single optional data store 106, such components may be illustrative of multiple devices or components operating collectively as part of the crowdfunding system 100. Indeed, the network 102 may include multiple interconnected networks, and which can facilitate communication between one or more of the end user devices 108-112. Similarly, the server 104 may represent multiple servers or other computing elements either located together or distributed in a manner that facilitates operation of one or more aspects of the crowdfunding system 100. Further still, while the optional data stores 106 are shown as a single storage device that is separate from the server 110 and the end user or client devices 108-112, in other embodiments the data stores 106 may be wholly or partially included within any other system, device or component, or may include multiple data stores 106 distributed among different locations and/or components. In some embodiments, the end user devices 108-112 may leverage the server 104 and/or the data stores 106 in a software-as-a-service (SAAS) or cloud-computing environment.

The network 102 may be configured to convey or transmit electronic communications between the one or more servers 104 and the end user devices 108-112. The Internet, mobile communications networks, other communication networks or channels or any combination of the forgoing may be represented by the network 102. Accordingly, the network 102, the devices thereof (e.g., the one or more servers 104, the data stores 106, etc.) and the devices connected to the network 102 (e.g., the end user devices 108-112, etc.) may operate in a number of different manners. Different manners of operation may be based at least in part on a type of the network 102 or a type of connection to the network 102. For instance, various components of the crowdfunding system 100 may include hard-wired communication components and/or wireless communication components or interfaces (e.g., CDMA, LTE, GSM, HSPA+, 802.11, Bluetooth, or other developed or to-be-developed wireless systems, etc.).

Thus, the network 102 may be used to enable the communication of information from the one or more servers 104 to the end user devices 108-112. Such communication may occur in any of a variety of formats that enable computer processors of the end user devices 108-112, while executing computer programs, such as web browsers or specialized software applications (e.g., so-called “apps” running on smart phones, media players, tablet computers, etc.), to output, or convey, the information to end users. Without limitation, the system 100 may provide information such as text, still images, audio, video, multi-media (e.g., any combination of the foregoing) and/or other formats.

Optionally, the crowdfunding system 100 or, more specifically, a server 104 of the crowdfunding system 100 may selectively convey information over the network 102 to one or more specified end user devices 108-112 in any of a number of different ways and/or formats. Without limitation, the server 104 may selectively convey information in an e-mail, messaging services (e.g., as a text message, as an instant message, etc.) or the like.

The end user devices 108-112 may comprise any of a number of different types of devices or components. The end user devices 108-112 may include, for instance, displays, speakers, or the like so as to enable an end user to view a user interface (e.g., a page, such as a web page, an app interface, etc.), as well as text, still images and video displayed in connection with the user interface and listen to audio associated with information displayed by the user interface. In various embodiments, the end user devices 108-112 may include computing or other types of electronic devices. Examples of suitable electronic devices may include smart phones, media players, tablet computing devices, laptop computers, desktop computers, other devices capable of communicating data over the network 102 or any combination of the foregoing. Accordingly, while FIG. 1 illustrates end user devices 108-112 as including a desktop computer 108, a laptop computer 110 and/or a mobile device 112 (e.g., a smart phone, a media player, a tablet computing device, etc.), such devices are merely illustrative. Indeed, other types of end user devices may be used in the crowdfunding system 100, and the crowdfunding system 100 may also include a plurality of end user devices of the same type.

Additionally, the network 102 may enable the transmission of information from an end user device 108-112 to the one or more servers 104 and/or data stores 106. In addition to being accessible to the one or more servers 104, such information may be available to one or more other end user devices 108-112, including other end user devices 108-112 associated with the user account that was initially used to convey the information to the one or more servers 104.

The particular manners in which the crowdfunding system 100 may be used will become more apparent in connection the ensuing description, which provides additional details about various aspects and embodiments of the disclosed subject matter.

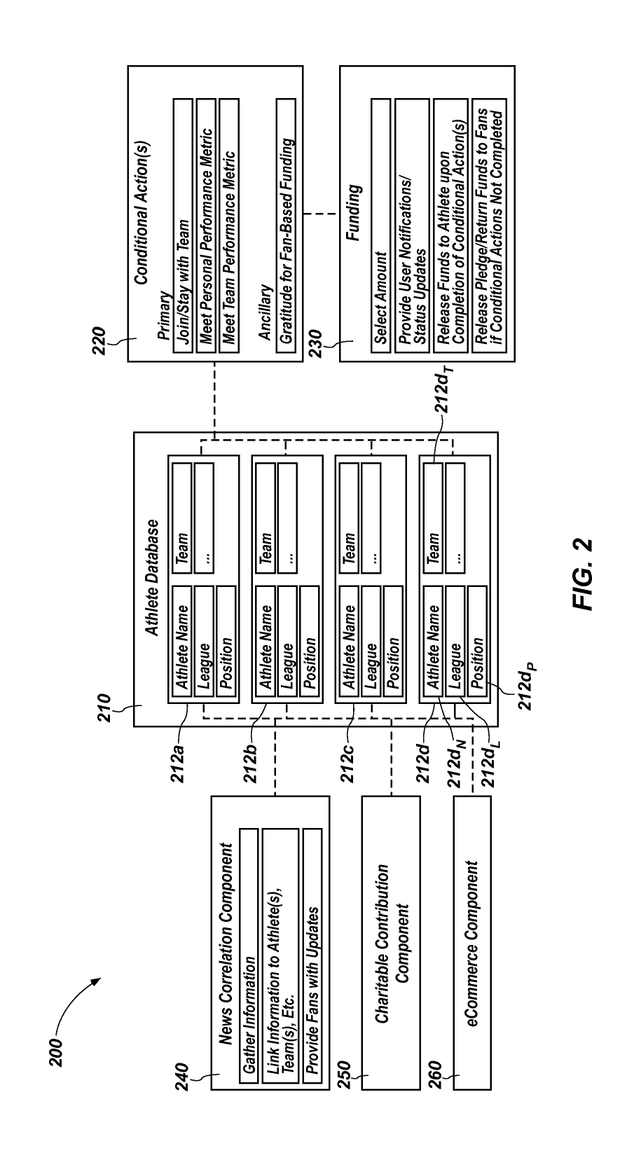

The one or more servers 104 of a crowdfunding system 100 according to this disclosure, along with data stores 106 associated with the one or more servers 104, may be used to administer a crowdfunding program. With reference to FIG. 2, a representation of the basic features of an embodiment of a crowdfunding program 200 according to this disclosure is depicted. As illustrated, the crowdfunding program 200 may comprise an athlete database 210, a conditional action component 220 and a funding component 230.

The athlete database 210 may include information about a number of individual athletes 212a, 212b, 212c, etc. That information may include the personal information about the athlete 212d, including, but not limited to, his or her name 212d_{N}, sport(s), league(s) 212d_{L}, playing position(s) 212d_{P}, age, hometown, playing history (e.g., school(s), professional team(s), etc.), current team 212d_{T}, a short biography, statistics, current contract status, salary or any combination of the foregoing.

A system administrator may populate the athlete database 210 with identities of various athletes 212a, 212b, 212c, etc., and with information about each athlete 212a, 212b, 212c, etc. The information for each athlete 212a, 212b, 212c, etc., may be updated periodically (e.g., as the athlete 212a's, 212b's, 212c's, etc., statistics change throughout a playing season (e.g., daily, after each game, at the end of each week, etc.), etc.) or based on other information, such as changes in the athlete 212a's, 212b's, 212c's, etc., team, playing status, contract status or the like. Users of the crowdfunding system 100 (FIG. 1) may request that a system administrator include one or more additional athletes in the athlete database 210, that new or additional information for one or more athletes be included in the athlete database 210 and/or that information in the athlete database be updated. In some embodiments, certain users of the crowdfunding system 100 (e.g., trusted users (e.g., based on their use history with the crowdfunding system 100, etc.), users who have contributed a certain amount to a particular athlete, etc.) may have rights to add athletes 212a, 212b, 212c, etc., to the athlete database 210, add athlete information to the athlete database 210 or update athlete information in the athlete database 210.

The information about each athlete 212a, 212b, 212c, etc., in the athlete database 210 may be organized in any manner known in the art. In some embodiments, the athlete database 210 may be indexed. Information from the athlete database 210 may be organized and/or searched on the basis of sport, with optional sub-organization or sub-searchability on the basis of league, conference, division, team and/or position. As another option, the athlete database 210 may be organized and/or searched based on geographic region, with optional sub-organization or sub-searchability on the basis of state, metropolitan area, city, team, etc. The manner in which information may be retrieved from the athlete database may be logical or intuitive, particularly from the perspective of a sports fan.

The conditional action component 220 may be associated with the athlete database 210 in any suitable manner. In some embodiments, the conditional action component 220 may comprise a database of predetermined conditional actions and/or conditional action templates. Some predetermined conditional actions and conditional action templates may be configured for association with any athlete, regardless of that athlete's sport, league or position. Other predetermined conditional actions and conditional action templates may be event-specific, sport-specific, or even league-specific (e.g., based on differences, including rules, between different leagues, etc.). Still other predetermined conditional actions and conditional action templates may be position-specific, as responsibilities and expectations in some sports (e.g., team sports, etc.) vary from one (playing) position to another.

Alternatively, a conditional action may be tailored specifically for a particular athlete. Such a conditional action may be added to the conditional action component 220, but associated with the athlete for whom the conditional action has been tailored. A system administrator may define a tailored conditional action, with or without input from users of the crowdfunding system 100. In embodiments where users of the crowdfunding system 100 are able to provide a system administrator with recommendations regarding a conditional action that is tailored for a particular athlete, such recommendations may be provided on a user's own initiative. Alternatively, a user may provide a recommendation on a tailored conditional action in response to an invitation from the system administrator, which invitation may be received based on the user's expressed interest in the athlete (e.g., from a prior contribution to the athlete, based on a request from the user to participate in developing conditional actions for the athlete, based on the user's prior access to the athlete's page in the crowdfunding system 100, based on web analytics relating to the user's interest in the athlete, etc.). Conditional actions may be defined on the basis of a consensus between a plurality of users, with the consensus being derived from a plurality of common conditional actions that have been submitted by a plurality of users. In some embodiments, some users (e.g., trusted users (e.g., based on their use history with the crowdfunding system 100, etc.), users who have contributed a certain amount to a particular athlete, etc.) may be permitted to individually define a conditional action that has been tailored to a particular athlete.

Without limitation, a conditional action may include a specific metric by which an athlete's individual performance is measured over a game, over a season, during a post-season, tournament or championship game, etc. An individual performance-based predetermined conditional action or conditional action template may be position-specific and, thus, may only be associated with athletes who play a particular position. A position-specific metric may be based on statistics that are typically associated with the relevant position.

As another option, a conditional action may be based on an athlete's association or continued association with a particular team. For example, the conditional action may involve an athlete signing a contract to play for a particular team. The conditional action may also include other, more specific parameters, such as the length of the contract (e.g., the length of the contract must meet or exceed a certain threshold, etc.), the value of the contract (e.g., a value that reflects a “home-town” discount, a comparison of the value to annual contract values for other athletes of similar skills and/or popularity who play the same position, a value that is less than a so-called “max deal” permissible for the athlete, a value that is equal to a max deal permissible for the athlete, etc.), the presence or absence of one or more player options in the contract, the presence or absence of one or more team options in the contract, individual performance incentives in the contract, team performance incentives in the contract and/or any other contract provision.

In some embodiments, an ancillary conditional action may be required of an athlete before he or she receives compensation for completing a primary conditional action, (e.g., a performance-based metric, signing a contract extension or a new contract, etc.). In a specific embodiment, the ancillary conditional action may comprise a public acknowledgement of and appreciation for users of the crowdfunding system 100 (FIG. 1) who contributed to the athlete for completing the conditional action. In another specific embodiment, the ancillary conditional action may be a personal act of thanks from the athlete to one or more users who have contributed to the athlete for his or her completion of the conditional action. When a personal act of thanks is required, the extent to which athlete must thank a particular user may correspond to the magnitude of the user's contribution to the athlete.

Conditional actions from the conditional action component 220 may be associated with a particular athlete through a web page dedicated to that athlete. Without limitation, a user may locate (e.g., from a pull-down menu, a link, etc.), search for (e.g., through a search bar, etc.) and/or define a conditional action (e.g., using a template, in free form, etc.) for the athlete through the athlete's dedicated web page. Upon selecting or defining a conditional action for an athlete, the user may decide to contribute money or to pledge to contribute money to the athlete if the athlete completes the conditional action. The amount of the contribution or pledge may be fixed. Alternatively, the user may determine an amount of money he or she will pay the athlete upon the athlete's completion of the conditional action. In embodiments where a user may determine the amount he or she will contribute or pledge to an athlete, minimum contribution amounts and/or maximum contribution amounts may be set.

In some embodiments, a portion of the amount of money pledged to the athlete may be given to one or more additional parties when the athlete has met each required conditional action or when the money becomes accessible to the athlete. As an example, a percentage of the money pledged to an athlete may be paid to the administrator of the crowdfunding system, to one or more organizations with which the athlete is associated (e.g., his or her school, the conference in which he or she plays, a governing body (e.g., an athletic association, such as the NCAA, etc.), etc.), to one or more charitable organizations or the like. In a specific embodiment, the administrator of the crowdfunding system may receive a first percentage of each pledge, an organization with which the athlete is associated may receive a second percentage of each pledge and a charitable foundation may receive a third percentage of each pledge.

A record of all pledges and contributions that are made in connection with a particular athlete and one or more conditional actions by that athlete is maintained by the funding component 230 of the crowdfunding program 200. In addition, the funding component 230 may be configured to receive funds from users (e.g., from electronic funds transfers (EFTs), from bank card transactions, from funds in a user deposit account associated with the funding component 230, etc.) (i.e., from a server or other computer of the users' financial institutions, as instructed by the users (e.g., in person, by way of an automated teller machine (ATM), by way of a personal computer, by way of a portable electronic device, etc.)). The funding component 230 may communicate with, or even comprise, a financial institution with which escrow accounts have been established for various athletes, or one or more servers or computers of the banking institution. As an alternative to receiving funds that will be held in escrow, the funding component 230 may be configured to receive a pledge for a financial transaction that will be consummated upon an athlete's completion of one or more conditional actions.

The funding component 230 may also be configured to remit funds to an athlete once the athlete has fulfilled the conditional action(s) with which those funds are associated. In embodiments where a percentage of funds are to be transferred to additional parties (e.g., the administrator of the crowdfunding system, an organization with which the athlete is associated, a charitable organization, etc.), those funds may be distributed to the appropriate entities when the athlete complies with the required conditional action(s). Accordingly, the funding component 230 may be configured to communicate with banking institutions with which various athletes and, optionally, any designated third party(ies) has (have) set up accounts for receiving funds from the crowdfunding system 100. In some embodiments, the funding component 230 may include such accounts. In embodiments where funds are held in an escrow account pending an athlete's completion of one or more conditional actions, the funding component 230 may be configured to release such funds from the escrow account when the athlete completes the one or more conditional actions. The funds may be released into an account designated by the athlete, or the funds may be provided to the athlete in the form of a check or in any other suitable manner. In embodiments where the funding component 230 has received a pledge for funds from user and the athlete has completed each conditional action required of the athlete to receive the funds, the funding component 230 may consummate the transaction (e.g., an electronic funds transfer (EFT), a bank card transaction, etc.).

In situations where an athlete does not complete a conditional action within a designated time period, the funding component 230 may be configured to release the funds back to the contributing user or to cancel any conditional transactions based on pledges made by one or more users.

In addition, the funding component 230 may be configured to provide the user(s) and the athlete with notifications regarding the athlete's completion of or failure to complete one or more conditional actions, as well as information on the release of funds to the athlete (in situations where the athlete has completed all required conditional actions associated with the funds) or on the reimbursement of funds or release of pledges (in situations where the athlete has failed to complete all required conditional actions associated with the funds).

In addition to the athlete database 210, the conditional action component 220 and the funding component 230, a crowdfunding program 200 may include any of a number of other optional features. Without limitation, a crowdfunding program 200 may include a news correlation component 240, which may obtain news from any of a variety of sources (e.g., sports news websites, league websites, team websites, athletes' websites, etc.) and associate such news with the athletes, teams, leagues and sports to which the news applies, making the news available to users who are interested in learning more about one or more athletes, teams, leagues and/or sports. In some embodiments, the news correlation component 240 may be configured to access social media sites to obtain information about athletes. The crowdfunding program 200 may also be configured to provide users with direct notifications or updates (e.g., through a messaging account, via e-mail, etc.) when new information has been located for a particular athlete, team, league or sport. Such notifications may be provided when requested by a user or based on another indicator of the user's interest in the athlete, team, league or sport (e.g., from prior contributions made by the user, based on the user's prior access to the athlete's, team's, league's or sports' page in the crowdfunding system 100, based on web analytics relating to the user's interest in the athlete, team, league or sport, etc.).

In embodiments where the crowdfunding program 200 includes a news correlation component 240 and where the athlete is required to thank his or her contributing fans after completing a conditional action but prior to receiving the funds that have been contributed for his or her completion of that conditional action, the news correlation component 240 may automatically confirm that the athlete has acknowledged and expressed gratitude for his or her contributing fans (e.g., in a required manner, such as in the news, via social media, etc.). Once the news correlation component 240 has automatically confirmed that the athlete has expressed the required thanks, the news correlation component 240 may communicate such information to the funding component 230, which may then automatically release the funds to the athlete or directly to a bank account controlled by the athlete or his or her representatives (e.g., to a server or another computer of a financial institution that administers the bank account, etc.).

As another option, a crowdfunding program 200 may include a charitable contribution component 250, which may provide users with access to charitable causes with which certain athletes, teams or leagues are associated, and enable users to contribute or otherwise participate in such charitable causes.

In yet another option, a crowdfunding program 200 may include an e-commerce component 260, which may correlate with products and/or services that are associated with an athlete (e.g., endorsed by the athlete, licensed by the athlete, etc.), a team, a conference or a league. Such an e-commerce component 260 may provide users with links to websites from which the products and/or services may be purchased.

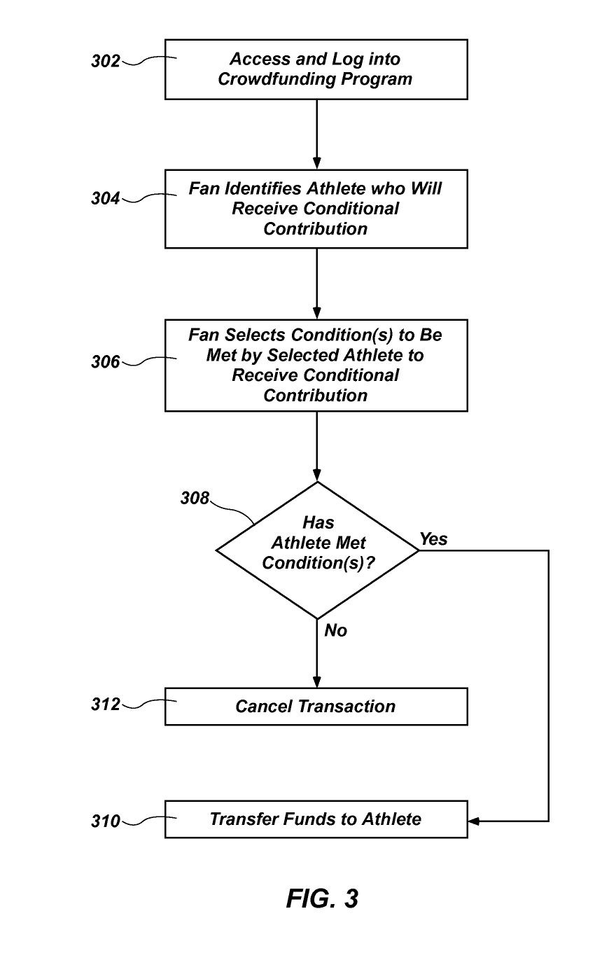

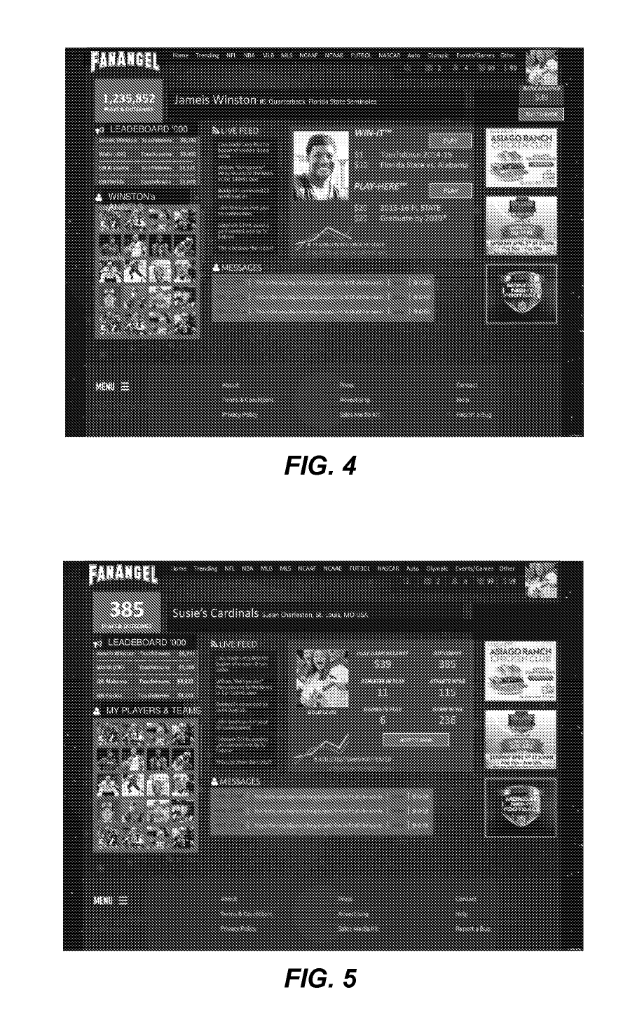

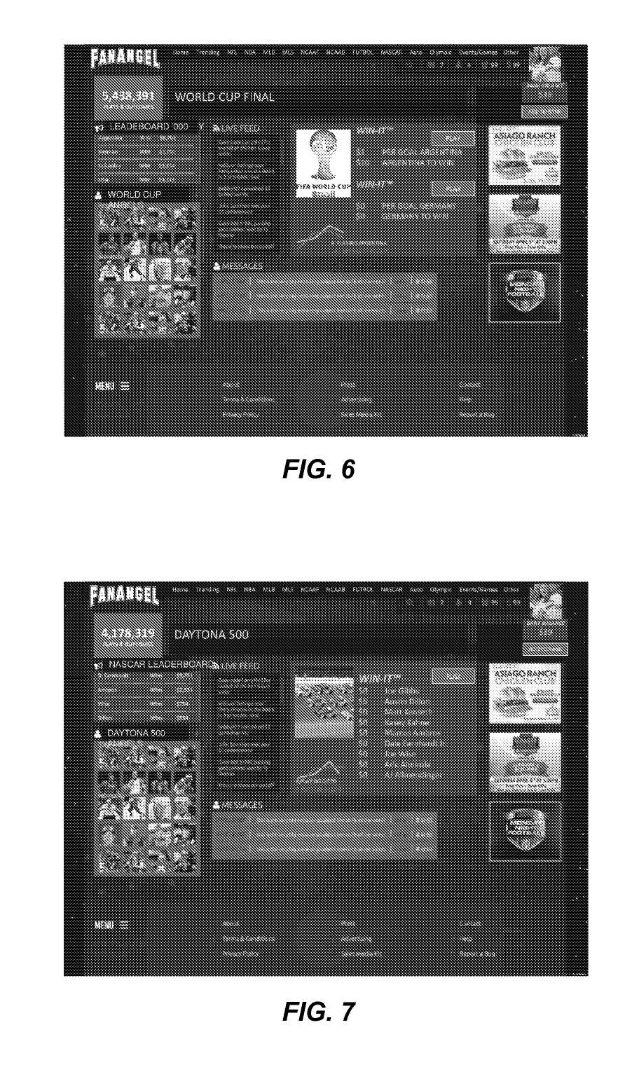

With reference to the flow diagram of FIG. 3, an embodiment of a method of using a crowdfunding system 100 (FIG. 1) and crowdfunding program 200 (FIG. 2) according to this disclosure is described. At reference 302, a user may access and log into the crowdfunding system 100. The user may access and log into the crowdfunding system 100 through an internet browser on a computer or a mobile computing device (e.g., a tablet computer, a smart phone, etc.) or through a specialized app. The user may interact with the crowdfunding program 200 in a variety of different ways. Without limitation, the user may access a web page that has been customized by the user, as shown in FIG. 4. Alternatively, the user may access a web page that corresponds to a particular athlete, such as the web page shown in FIG. 5. As another alternative, the user may access and use the crowdfunding program 200 through a sporting event page, such as those depicted by FIGS. 6 and 7.

With returned reference to FIG. 3, once the user has accessed and logged into the crowdfunding system 100 (FIG. 1), the user may identify an athlete to whom he or she may want to contribute at reference 304. The user may identify the athlete directly, through the athlete's sport, league, conference, division and/or team or through the geographic location where the athlete plays.

Next, at reference 306, the user may select one or more conditional actions to be completed by the athlete of interest, and contribute or pledge to contribute a certain amount of money to the athlete if the athlete completes the one or more conditional actions. The user may receive confirmation of the contribution or the pledged contribution, as well as an opportunity to withdraw or modify the contribution or the pledged contribution (which opportunity may be time-limited). In addition, the athlete may receive notifications regarding each conditional action for which he or she may receive money from users of the crowdfunding system 100 (FIG. 1).

At reference 308, a determination is made as to whether or not the athlete has completed the conditional action(s) in accordance with all of the requirements associated with each conditional action.

If the athlete has completed each conditional action, the funds associated with that conditional action are released to the athlete at reference 310 of FIG. 3. If the athlete does not complete each conditional action, the funds associated with that conditional action may be returned to the user(s) who contributed the funds and/or each user pledge associated with the conditional action may be cancelled, at reference 312 of FIG. 3.

Although the preceding disclosure provides many specifics, these should not be construed as limiting the scope of any of the ensuing claims. Other embodiments may be devised which do not depart from the scopes of the claims. Features from different embodiments may be employed in combination. The scope of each claim is, therefore, indicated and limited only by its plain language and the full scope of available legal equivalents to its elements.

What is claimed:

1. A system for establishing enabling sports fans to provide athletes with financial incentives, comprising at least one server that administers:
an athlete database that includes information about a plurality of athletes;
a conditional action component that associates conditional actions with selected athletes whose information is stored on the athlete database;
a user interface in communication with the account center, the user interface configured to enable a customer to:
select a selected athlete;
select at least one conditional action for the selected athlete; and
select an amount of money to be contributed to the selected athlete if the selected athlete completes the at least one conditional action; and
a funding component that:
transfers funds from sports fans to an escrow account held on behalf of the selected athlete when the selected athlete completes a conditional action; and
transfers the funds from the escrow account to the selected athlete upon completion of the selected athlete's amateur status.

2. The system of claim 1, wherein the conditional action comprises a performance-based action.

3. The system of claim 1, wherein the conditional action corresponds to the selected athlete's association with a particular team.

4. The system of claim 1, wherein the conditional action comprises a primary conditional action and an ancillary conditional action is associated with the primary conditional action.

5. The system of claim 1, wherein the ancillary conditional action is an act of gratitude from the selected athlete to at least one user.

6. The system of claim 1, wherein the user interface comprises a mobile app.

7. The system of claim 1, wherein the funding component includes:
an account center for administering financial accounts for the selected athlete, the account center including:
another escrow account for receiving funds from users, the other escrow account configured to:
transfer funds conditionally contributed by the user to the escrow account for the selected athlete when the selected athlete completes the conditional action; or
refund at least a portion of the money to the user if the selected athlete does not complete the conditional action by a predetermined point in time.

8. The system of claim 1, wherein the funding component includes:
a financial account for each of a plurality of selected athletes, the funding component configured to automatically transfer funds into the financial account when the athlete completes the conditional action.

9. The system of claim 1, wherein the funding component is configured to:
receive a pledge from a user to contribute funds to the selected athlete if the selected athlete completes the conditional action;
receive financial information from the user; and
consummate a financial transaction based on the pledge in the event that the selected athlete completes the conditional action.

10. The system of claim 9, wherein the funding component is further configured to:
return the funds to the user in the event that the selected athlete does not complete the conditional action.

11. The system of claim 1, further comprising:
a news correlation component configured to locate news or other information regarding an athlete of the plurality of athletes and updating a profile for the athlete based on the news or other information.

12. The system of claim 11, wherein the new correlation component is further configured to provide selected users with notifications of update to the profile for the athlete.
